(19) United States
(12) Patent Application Publication
(10) Pub. No.: US 2018/0098052 A1
(43) Pub. Date: Apr. 5, 2018

(54) TRANSLATION OF PHYSICAL OBJECT VIEWED BY UNMANNED AERIAL VEHICLE INTO VIRTUAL WORLD OBJECT

(71) Applicant: SONY INTERACTIVE ENTERTAINMENT INC., Tokyo (JP)

(72) Inventor: Glenn Black, San Mateo, CA (US)

(21) Appl. No.: 15/393,855

(22) Filed: Dec. 29, 2016

Related U.S. Application Data
(60) Provisional application No. 62/402,811, filed on Sep. 30, 2016.

(51) Int. Cl. H04N 13/02; G06T 17/00

(52) U.S. Cl. CPC H04N 13/0275; G06T 17/00; G06T 2200/08; G06T 2207/10016; G06T 2207/10028

(57) ABSTRACT

An unmanned aerial vehicle (UAV) may capture a camera feed via a camera of the UAV. Translation instructions stored by a translation server that stores and transmits translation instructions. The translation instructions identify a pre-translation object and a corresponding post-translation object. An instance of the pre-translation object is recognized in the camera feed, and the camera feed is modified to replace the instance of the pre-translation object with an instance of the corresponding post-translation object. The modified camera feed is then transmitted to a display through which the modified camera feed is displayed.

### CROSS REFERENCE TO RELATED APPLICATIONS

The present application claims the priority benefit of U.S. patent application 62/402,811 filed Sep. 30, 2016, the disclosure of which is incorporated herein by reference.

### BACKGROUND

### 1. Field of the Invention

The present invention generally concerns unmanned aerial vehicles and computer vision. More particularly, the present invention concerns recognizing physical objects in a camera feed and translating the recognized physical objects into corresponding virtual objects.

### 2. Description of the Related Art

Unmanned aerial vehicles (UAVs), sometimes referred to as “drones,” are aerial vehicles that are either autonomous, remote-controlled by a user with a control transmitter, or some combination thereof. UAVs can sometimes include cameras that record images or videos of the physical world as seen by the field of view of the camera.

Augmented reality refers to a view of a physical, real-world environment whose elements are augmented or supplemented by computer-generated sensory input. For example, augmented reality may include the view of the physical environment with text or images adding to or replacing elements of the view of the physical environment. Augmented reality may also insert or replace sounds with computer-generated sounds.

Virtual reality refers to technologies that generate, typically via compute software, a virtual world environment whose elements have little or no relationship to any physical, real-world environment. A virtual reality experience is typically intended to replace, rather than augment or supplement, an experience of any physical reality. Virtual reality typically include entirely computer-generated graphics and sounds.

Display technologies include display screens, such as liquid crystal display (LCD) display screens or organic light emitting diode (OLED) screens. Display technologies also include projectors, such as movie projectors. Displays can be included in typical monitors or televisions, in handheld devices such as cellular phones or tablet devices, or in head-mounted displays such as goggles or glasses.

### SUMMARY OF THE PRESENTLY CLAIMED INVENTION

A first claimed embodiment of the present invention involves a method for visual translation. The method includes storing a translation rule in a memory, the translation rule identifying a pre-translation object and a post-translation object that corresponds to the pre-translation object. The method also includes receiving a camera feed from a camera of an unmanned aerial vehicle (UAV) and recognizing an instance of the pre-translation object within the camera feed. The method also includes modifying the camera feed to replace the instance of the pre-translation object in the camera feed with an instance of the post-translation object. The method also includes transmitting the modified camera feed to a display, thereby triggering display of the modified camera feed via the display.

A second claimed embodiment of the present invention concerns a system for visual translation. The system includes a memory that stores a translation rule, the translation rule identifying a pre-translation object and a post-translation object that corresponds to the pre-translation object. The system also includes a communication transceiver that receives a camera feed from a camera of an unmanned aerial vehicle (UAV). The system also includes a processor coupled to the memory. Execution of instructions stored in the memory by the processor performs system operations. The system operations include recognizing an instance of the pre-translation object within the camera feed, modifying the camera feed to replace the instance of the pre-translation object in the camera feed with an instance of the post-translation object, and triggering transmission of the modified camera feed to a display via the communication transceiver, thereby triggering display of the modified camera feed via the display.

A third-claimed embodiment of the present invention concerns a non-transitory computer-readable storage medium having embodied thereon a program executable by a processor to perform a method for visual translation. The executable method includes storing a translation rule in a memory, the translation rule identifying a pre-translation object and a post-translation object that corresponds to the pre-translation object. The executable method also includes receiving a camera feed from a camera of an unmanned aerial vehicle (UAV) and recognizing an instance of the pre-translation object within the camera feed. The executable method also includes modifying the camera feed to replace the instance of the pre-translation object in the camera feed with an instance of the post-translation object. The executable method also includes transmitting the modified camera feed to a display, thereby triggering display of the modified camera feed via the display.

### BRIEF DESCRIPTION OF THE DRAWINGS

FIG. 1 illustrates a translation of a field of view from an unmanned aerial vehicle (UAV) into a virtual field of view of a display according to translation instructions from a translation server.

FIG. 2A illustrates a field of view from an unmanned aerial vehicle (UAV).

FIG. 2B illustrates a translated field of view portraying an augmented reality virtual world with inserted content as shown by a display.

FIG. 2C illustrates a translated field of view portraying an augmented reality virtual world with translated content as shown by a display.

FIG. 2D illustrates a translated field of view portraying a virtual reality virtual world with translated content as shown by a display.

FIG. 3 illustrates an unmanned aerial vehicle (UAV).

FIG. 4 illustrates a control transmitter for an unmanned aerial vehicle (UAV).

FIG. 5 illustrates a head-mounted display.

FIG. 6 is a block diagram of an exemplary computing device that may be used to implement an embodiment of the present invention.

### DETAILED DESCRIPTION

An unmanned aerial vehicle (UAV) may capture a camera feed via a camera of the UAV. Translation instructions stored by a translation server that stores and transmits translation instructions. The translation instructions identify a pre-translation object and a corresponding post-translation object. An instance of the pre-translation object is recognized in the camera feed, and the camera feed is modified to replace the instance of the pre-translation object with an instance of the corresponding post-translation object. The modified camera feed is then transmitted to a display through which the modified camera feed is displayed.

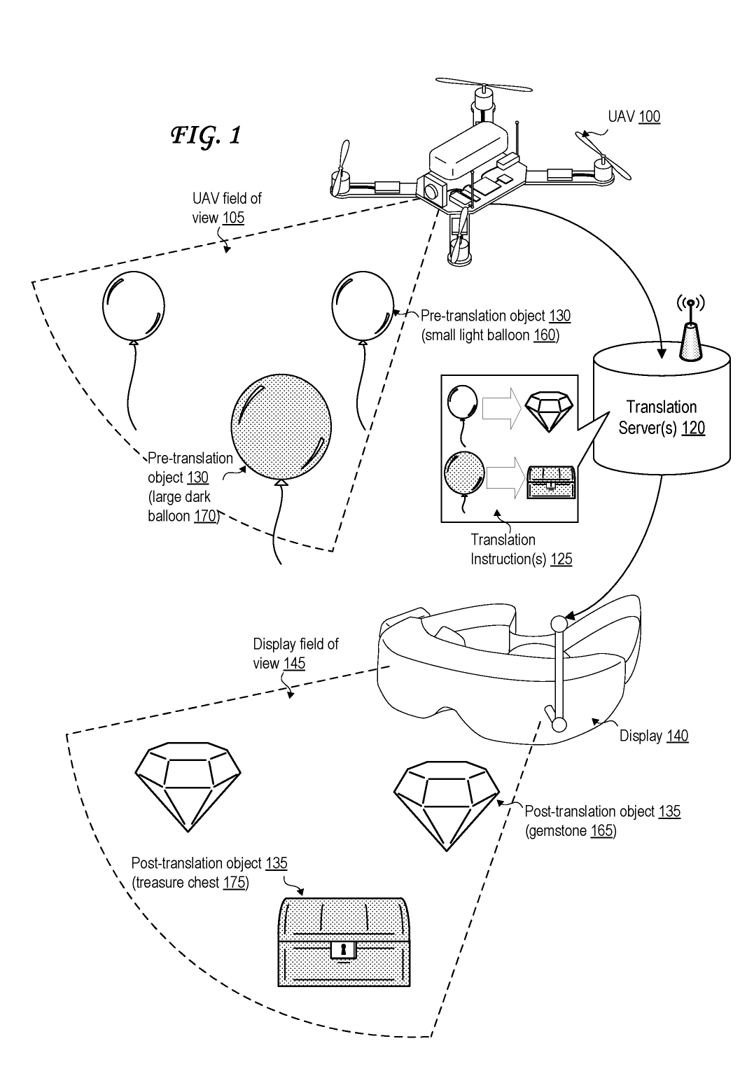

FIG. 1 illustrates a translation of a field of view from an unmanned aerial vehicle (UAV) into a virtual field of view of a display according to translation instructions from a translation server.

The unmanned aerial vehicle (UAV) 100 of FIG. 1 includes a camera 305 that captures images or videos of a field of view 105 of the camera 305. The field of view 105 may include a number of pre-translation objects 130, which in FIG. 1 include two small light-colored balloons 160 and one large dark-colored balloon 170. The images or videos captured by the UAV 100 may be stored and transmitted later by the UAV 100 via wired or wireless means, or may be sent out in real-time via a live stream of images or video. The images or videos captured by the UAV 100 may be sent out unmodified, or may be modified by the UAV 100 before transmission, either using image/video compression or any of the translation procedures discussed in relation to the translation instructions 125.

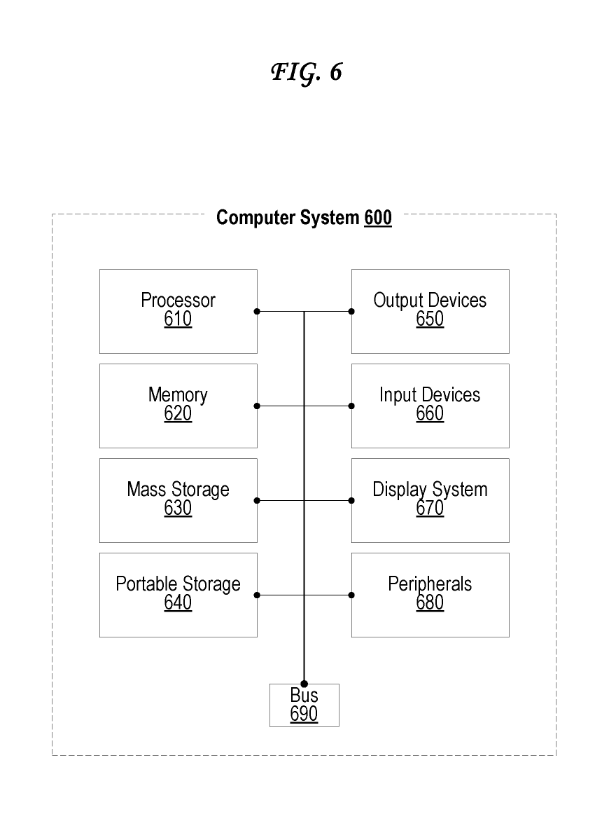

The display 140 of FIG. 1 is a head-mounted display, but may be any other type of display discussed in relation to FIG. 5 or FIG. 6. The display 140 displays a field of view 145 that is at least partially based on the UAV field of view 105.

A translation server 120 may communicate with the UAV 100 and/or the display 140 either before, during, or after the UAV 100 captures the images or videos of its field of view 105, or some combination thereof. The translation server 120 may include one or more translation instructions 125 that identify, for each of a number of pre-translation objects 130, a corresponding post-translation object 135 that the pre-translation object 130 should be translated into before it is sent to a display 140 to be displayed. The images or videos captured by the UAV 100 may be modified to translate the pre-translation objects 130 to their corresponding post-translation objects 135 by a computing device 600 onboard the UAV 100, by the translation server 120, by a computing device 140 onboard the display 140, by an external computing device in communication with one of these devices (not shown), or some combination thereof.

For example, the translation instructions 125 of FIG. 1 identify that any small light-colored balloons 160 within the UAV field of view 105 should be translated into gemstones 165. Therefore, the display field of view 145 shows gemstones 165 where the UAV field of view 105 shows small light-colored balloons 160. The translation instructions 125 of FIG. 1 also identify that any large dark-colored balloons 170 within the UAV field of view 105 should be translated into treasure chests 175. Therefore, the display field of view 145 shows a treasure chest 175 where the UAV field of view 105 shows a large dark-colored balloon 170.

The work of recognizing instances of the pre-translation objects 130 may be performed using a number of computer vision techniques by a computing device 600 onboard the UAV 100, by the translation server 120, by a computing device 140 onboard the display 140, by an external computing device in communication with one of these devices (not shown), or some combination thereof. The computer vision techniques may include edge detection, tracking, pattern recognition, character recognition, 3D segmentation, 3D modeling, counting, quantification, machine learning, face detection, logo detection, optical character recognition, barcode scanning, quick response (QR) code scanning, or some combination thereof. The camera feed may include data from multiple cameras to provide depth perception and identify distances from instances of pre-translation objects 130 and/or sizes of instances of pre-translation objects 130. The camera feed may include data from a distance measurement system, such as a laser rangefinder, a radar device, a sonar device, or a lidar device, to provide depth perception and identify distances from instances of pre-translation objects 130 and/or sizes of instances of pre-translation objects 130. Instances of pre-translation objects may be recognized based on one or more shapes, one or more colors, one or more brightness levels, one or more contrast levels, a relative size, an absolute size, one or more facial features, one or more logos, one or more barcodes, one or more QR codes, one or more reference points, or some combination thereof.

The work of replacing instances of the pre-translation objects 130 with instances of the corresponding post-translation objects 135 may be performed using a number of computer vision techniques by a computing device 600 onboard the UAV 100, by the translation server 120, by a computing device 140 onboard the display 140, by an external computing device in communication with one of these devices (not shown), or some combination thereof. This replacement work may include simply overlaying the recognized instance of the pre-translation object 130 with an instance of the corresponding post-translation object 135, but it may also include additional image processing steps, for example to first “erase” parts of the recognized instance of the pre-translation object 130. This may be performed automatically via image processing methods such as pattern matching, stamping, image stitching, blurring, smudging, liquefying, copying and pasting of background pixels from another location and/or time within the camera feed, or some combination thereof.

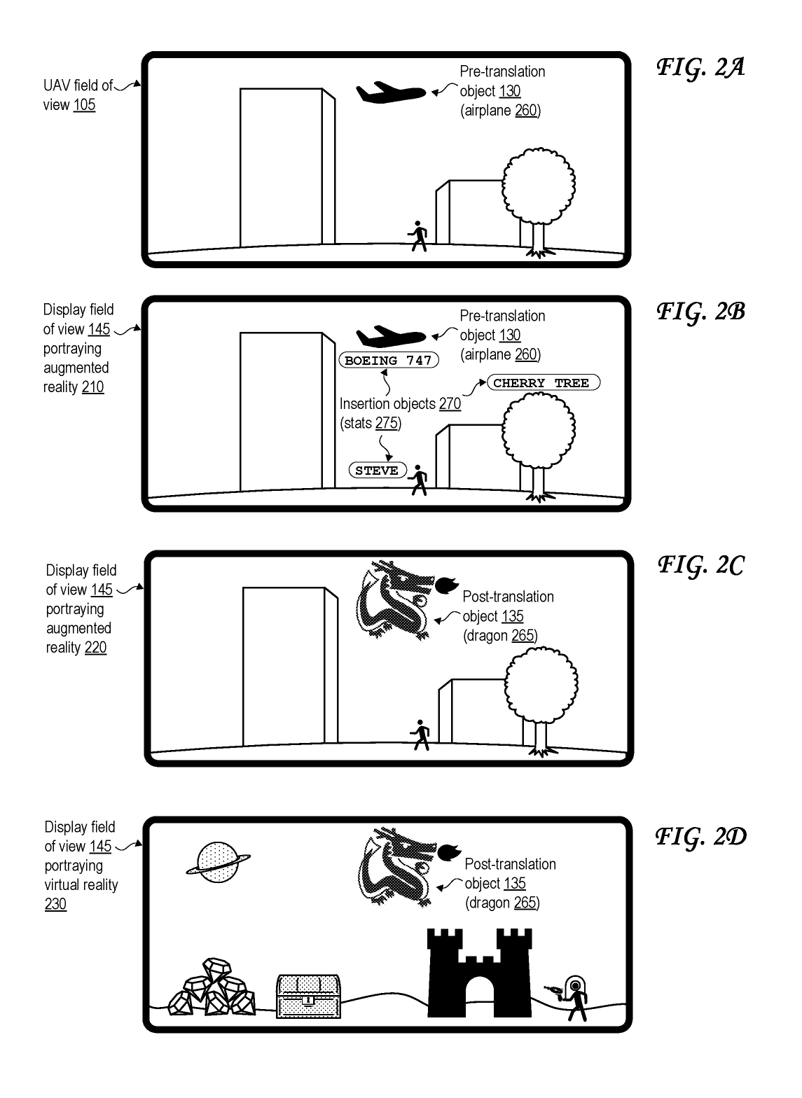

Additional image processing may be performed by the same device that recognizes the instances of the pre-translation objects 130 and/or that replaces the instances of the pre-translation objects 130 with the instances of the corresponding post-translation objects 135. For example, various insertion objects 270 may be inserted into the UAV field of view 105 to modify the UAV field of view 105 before it is seen at the display 140 as shown in the augmented reality 210 of FIG. 2B. Various computer-generated graphics may replace other elements as shown in the virtual reality 230 of FIG. 2D. Various filters adjusting brightness, contrast, saturation, hues, colors, white balance, levels, and other image traits may also be tweaked.

The camera feed may also include audio. Audio processing may be performed by the same device that recognizes the instances of the pre-translation objects 130 and/or that replaces the instances of the pre-translation objects 130 with the instances of the corresponding post-translation objects 135. In particular, the translation instructions 125 may identify audio translations that replace any recognized instances of pre-translation audio clips with corresponding post-translation audio clips. Audio may also be inserted or removed. For example, music may be added, a UAV rotor sound from the rotors of the UAV rotors may be replaced with spaceship thruster noises, and a car honking sound may be replaced with a dragon's roar.

The translation server 120 may in some cases send these translation instructions and/or handle translation for multiple UAVs. For example, multiple UAVs may be flying in an arena to play a competitive game in which objects are meant to be collected or destroyed. These UAVs may be controller by owners using control transmitters 400 to control the UAVs 100 and wearing displays 140 to see the “game world,” which may be an augmented reality version of the UAV field of view 105 or a virtual reality version of the UAV field of view 105. Actual physical balloons 160/170 or other objects may be let loose in the arena. The owners of each UAV 100, however, would instead see through their displays 140 coins, or gemstones 165, or treasure chests 175, or dragons 265, or other post-translation “objects” 135. These post-translation objects 135 may be portrayed through the display 140 as 2D images, 3D models, 2D videos, or 3D videos (e.g., animated 3D models).

While the translation instructions 125 are illustrated as being stored by the translation server 125, it should be understood that they may instead be stored by a computing device 600 onboard the UAV 100, by a computing device 140 onboard the display 140, by an external computing device in communication with one of these devices (not shown), or some combination thereof.

FIG. 2A illustrates a field of view from an unmanned aerial vehicle (UAV).

The UAV field of view 105 from the UAV 100 shows a scene in the physical world that includes a person, two buildings, a tree, and an airplane 260. The airplane 260 is an instance of an airplane pre-translation object 130, meaning that a translation instruction 125 exists identifying the airplane as a pre-translation object 130.

FIG. 2B illustrates a translated field of view portraying an augmented reality virtual world with inserted content as shown by a display.

The augmented reality virtual world 210 of FIG. 2B does not use the translation instructions 125, but instead inserts insertion objects 270, in this case inserting identifying statistics 275 next to the various objects in the scene. For example, the statistics 275 identify that the airplane 260 is a Boeing 747, that the tree is a cherry tree, and that the person is Steve. Different statistics 275 might identify other characteristics of particular objects, such as locations (e.g., latitude and longitude), relative speeds, absolute speeds, acceleration levels, or some combination thereof.

Rules regarding insertion of insertion objects 270 may be stored along with the translation rules. Removal rules may also identify objects to be removed (without replacement with a corresponding post-translation object) using the image processing techniques discussed above.

FIG. 2C illustrates a translated field of view portraying an augmented reality virtual world with translated content as shown by a display.

The augmented reality worlds 220 of FIG. 2C is very similar to the UAV field of view 105 of FIG. 2A, but with the airplane 260 replaced with a dragon 265. Based on the presence of the dragon 265, it should be inferred that the translation instructions 125 associated with the display field of view 145 of FIG. 2C indicate that the pre-translation object 130 of FIG. 2A—namely, the airplane 260—corresponds to the dragon 265 as a post-translation object 135.

Because the airplane 260 may move during a duration of time in which the camera feed is capturing video, the dragon 265 may then move within the augmented reality world 220 of FIG. 2C along the path that is actually followed by the airplane 260 in the physical world as seen through the UAV field of view 105 of FIG. 2A.

FIG. 2D illustrates a translated field of view portraying a virtual reality virtual world with translated content as shown by a display.

The virtual reality world 230 of FIG. 2D has little relationship to the UAV field of view 105 of FIG. 2A except that, much like in FIG. 2C, the dragon 265 exists as a post-translation object 135 of the pre-translation object 130 of FIG. 2A—namely, the airplane 260. Everything else in the virtual reality world 230 of FIG. 2D is a replacement, rather than an augmentation or supplementation, of the UAV field of view 105 of FIG. 2A.

Again, because the airplane 260 may move during a duration of time in which the camera feed is capturing video, the dragon 265 may then move within the virtual reality world 230 of FIG. 2D along the path that is actually followed by the airplane 260 in the physical world as seen through the UAV field of view 105 of FIG. 2A.

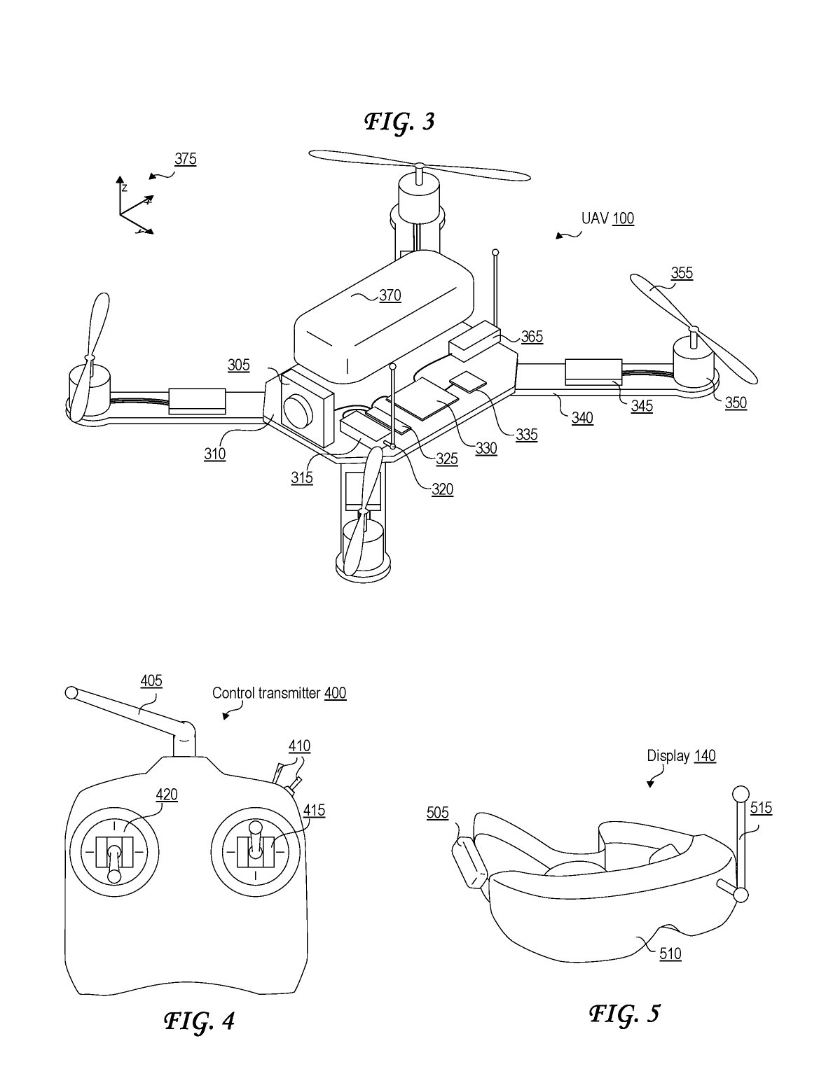

FIG. 3 shows unmanned aerial vehicle (UAV) 100 according to some embodiments. UAV 100 can have one or more motors 350 configured to rotate attached propellers 355 in order to control the position of UAV 100 in the air. UAV 100 can be configured as a fixed wing vehicle (e.g., airplane), a rotary vehicle (e.g., a helicopter or multirotor), or a blend of the two. For the purpose of FIG. 3, axes 375 can assist in the description of certain features. If UAV 100 is oriented parallel to the ground, the Z axis can be the axis perpendicular to the ground, the X axis can generally be the axis that passes through the bow and stern of UAV 100, and the Y axis can be the axis that pass through the port and starboard sides of UAV 100. Axes 375 are merely provided for convenience of the description herein.

In some embodiments, UAV 100 has main body 310 with one or more arms 340. The proximal end of arm 340 can attach to main body 310 while the distal end of arm 340 can secure motor 350. Arms 340 can be secured to main body 310 in an “X” configuration, an “H” configuration, a “T” configuration, or any other configuration as appropriate. The number of motors 350 can vary, for example there can be three motors 350 (e.g., a “tricopter”), four motors 350 (e.g., a “quadcopter”), eight motors (e.g., an “octocopter”), etc.

In some embodiments, each motor 355 rotates (i.e., the drive shaft of motor 355 spins) about parallel axes. For example, the thrust provided by all propellers 355 can be in the Z direction. Alternatively, a motor 355 can rotate about an axis that is perpendicular (or any angle that is not parallel) to the axis of rotation of another motor 355. For example, two motors 355 can be oriented to provide thrust in the Z direction (e.g., to be used in takeoff and landing) while two motors 355 can be oriented to provide thrust in the X direction (e.g., for normal flight). In some embodiments, UAV 100 can dynamically adjust the orientation of one or more of its motors 350 for vectored thrust.

In some embodiments, the rotation of motors 350 can be configured to create or minimize gyroscopic forces. For example, if there are an even number of motors 350, then half of the motors can be configured to rotate counter-clockwise while the other half can be configured to rotate clockwise. Alternating the placement of clockwise and counter-clockwise motors can increase stability and enable UAV 100 to rotate about the z-axis by providing more power to one set of motors 350 (e.g., those that rotate clockwise) while providing less power to the remaining motors (e.g., those that rotate counter-clockwise).

Motors 350 can be any combination of electric motors, internal combustion engines, turbines, rockets, etc. In some embodiments, a single motor 350 can drive multiple thrust components (e.g., propellers 355) on different parts of UAV 100 using chains, cables, gear assemblies, hydraulics, tubing (e.g., to guide an exhaust stream used for thrust), etc. to transfer the power.

In some embodiments, motor 350 is a brushless motor and can be connected to electronic speed controller X45. Electronic speed controller 345 can determine the orientation of magnets attached to a drive shaft within motor 350 and, based on the orientation, power electromagnets within motor 350. For example, electronic speed controller 345 can have three wires connected to motor 350, and electronic speed controller 345 can provide three phases of power to the electromagnets to spin the drive shaft in motor 350. Electronic speed controller 345 can determine the orientation of the drive shaft based on back-emf on the wires or by directly sensing to position of the drive shaft.

Transceiver 365 can receive control signals from a control unit (e.g., a handheld control transmitter, a server, etc.). Transceiver 365 can receive the control signals directly from the control unit or through a network (e.g., a satellite, cellular, mesh, etc.). The control signals can be encrypted. In some embodiments, the control signals include multiple channels of data (e.g., “pitch,” “yaw,” “roll,” “throttle,” and auxiliary channels). The channels can be encoded using pulse-width-modulation or can be digital signals. In some embodiments, the control signals are received over TC/IP or similar networking stack.

In some embodiments, transceiver 365 can also transmit data to a control unit. Transceiver 365 can communicate with the control unit using lasers, light, ultrasonic, infra-red, Bluetooth, 802.11x, or similar communication methods, including a combination of methods. Transceiver can communicate with multiple control units at a time.

Position sensor 335 can include an inertial measurement unit for determining the acceleration and/or the angular rate of UAV 100, a GPS receiver for determining the geolocation and altitude of UAV 100, a magnetometer for determining the surrounding magnetic fields of UAV 100 (for informing the heading and orientation of UAV 100), a barometer for determining the altitude of UAV 100, etc. Position sensor 335 can include a land-speed sensor, an air-speed sensor, a celestial navigation sensor, etc.

UAV 100 can have one or more environmental awareness sensors. These sensors can use sonar, LiDAR, stereoscopic imaging, computer vision, etc. to detect obstacles and determine the nearby environment. For example, a collision avoidance system can use environmental awareness sensors to determine how far away an obstacle is and, if necessary, change course.

Position sensor 335 and environmental awareness sensors can all be one unit or a collection of units. In some embodiments, some features of position sensor 335 and/or the environmental awareness sensors are embedded within flight controller 330.

In some embodiments, an environmental awareness system can take inputs from position sensors 335, environmental awareness sensors, databases (e.g., a predefined mapping of a region) to determine the location of UAV 100, obstacles, and pathways. In some embodiments, this environmental awareness system is located entirely on UAV 100, alternatively, some data processing can be performed external to UAV 100.

Camera 305 can include an image sensor (e.g., a CCD sensor, a CMOS sensor, etc.), a lens system, a processor, etc. The lens system can include multiple movable lenses that can be adjusted to manipulate the focal length and/or field of view (i.e., zoom) of the lens system. In some embodiments, camera 305 is part of a camera system which includes multiple cameras 305. For example, two cameras 305 can be used for stereoscopic imaging (e.g., for first person video, augmented reality, etc.). Another example includes one camera 305 that is optimized for detecting hue and saturation information and a second camera 305 that is optimized for detecting intensity information. In some embodiments, camera 305 optimized for low latency is used for control systems while a camera 305 optimized for quality is used for recording a video (e.g., a cinematic video). Camera 305 can be a visual light camera, an infrared camera, a depth camera, etc.

A gimbal and dampeners can help stabilize camera 305 and remove erratic rotations and translations of UAV 100. For example, a three-axis gimbal can have three stepper motors that are positioned based on a gyroscope reading in order to prevent erratic spinning and/or keep camera 305 level with the ground.

Video processor 325 can process a video signal from camera 305. For example video process 325 can enhance the image of the video signal, down-sample or up-sample the resolution of the video signal, add audio (captured by a microphone) to the video signal, overlay information (e.g., flight data from flight controller 330 and/or position sensor), convert the signal between forms or formats, etc.

Video transmitter 320 can receive a video signal from video processor 325 and transmit it using an attached antenna. The antenna can be a cloverleaf antenna or a linear antenna. In some embodiments, video transmitter 320 uses a different frequency or band than transceiver 365. In some embodiments, video transmitter 320 and transceiver 365 are part of a single transceiver.

Battery 370 can supply power to the components of UAV 100. A battery elimination circuit can convert the voltage from battery 370 to a desired voltage (e.g., convert 12 v from battery 370 to 5 v for flight controller 330). A battery elimination circuit can also filter the power in order to minimize noise in the power lines (e.g., to prevent interference in transceiver 365 and transceiver 320). Electronic speed controller 345 can contain a battery elimination circuit. For example, battery 370 can supply 12 volts to electronic speed controller 345 which can then provide 5 volts to flight controller 330. In some embodiments, a power distribution board can allow each electronic speed controller (and other devices) to connect directly to the battery.

In some embodiments, battery 370 is a multi-cell (e.g., 2S, 3S, 4S, etc.) lithium polymer battery. Battery 370 can also be a lithium-ion, lead-acid, nickel-cadmium, or alkaline battery. Other battery types and variants can be used as known in the art. Additional or alternative to battery 370, other energy sources can be used. For example, UAV 100 can use solar panels, wireless power transfer, a tethered power cable (e.g., from a ground station or another UAV 100), etc. In some embodiments, the other energy source can be utilized to charge battery 370 while in flight or on the ground.

Battery 370 can be securely mounted to main body 310. Alternatively, battery 370 can have a release mechanism. In some embodiments, battery 370 can be automatically replaced. For example, UAV 100 can land on a docking station and the docking station can automatically remove a discharged battery 370 and insert a charged battery 370. In some embodiments, UAV 100 can pass through docking station and replace battery 370 without stopping.

Battery 370 can include a temperature sensor for overload prevention. For example, when charging, the rate of charge can be thermally limited (the rate will decrease if the temperature exceeds a certain threshold). Similarly, the power delivery at electronic speed controllers 345 can be thermally limited—providing less power when the temperature exceeds a certain threshold. Battery 370 can include a charging and voltage protection circuit to safely charge battery 370 and prevent its voltage from going above or below a certain range.

UAV 100 can include a location transponder. For example, in a racing environment, race officials can track UAV 100 using location transponder. The actual location (e.g., X, Y, and Z) can be tracked using triangulation of the transponder. In some embodiments, gates or sensors in a track can determine if the location transponder has passed by or through the sensor or gate.

Flight controller 330 can communicate with electronic speed controller 345, battery 370, transceiver 365, video processor 325, position sensor 335, and/or any other component of UAV 100. In some embodiments, flight controller 330 can receive various inputs (including historical data) and calculate current flight characteristics. Flight characteristics can include an actual or predicted position, orientation, velocity, angular momentum, acceleration, battery capacity, temperature, etc. of UAV 100. Flight controller 330 can then take the control signals from transceiver 365 and calculate target flight characteristics. For example, target flight characteristics might include “rotate x degrees” or “go to this GPS location”. Flight controller 330 can calculate response characteristics of UAV 100. Response characteristics can include how electronic speed controller 345, motor 350, propeller 355, etc. respond, or are expected to respond, to control signals from flight controller 330. Response characteristics can include an expectation for how UAV 100 as a system will respond to control signals from flight controller 330. For example, response characteristics can include a determination that one motor 350 is slightly weaker than other motors.

After calculating current flight characteristics, target flight characteristics, and response characteristics flight controller 330 can calculate optimized control signals to achieve the target flight characteristics. Various control systems can be implemented during these calculations. For example a proportional-integral-derivative (PID) can be used. In some embodiments, an open-loop control system (i.e., one that ignores current flight characteristics) can be used. In some embodiments, some of the functions of flight controller 330 are performed by a system external to UAV 100. For example, current flight characteristics can be sent to a server that returns the optimized control signals. Flight controller 330 can send the optimized control signals to electronic speed controllers 345 to control UAV 100.

In some embodiments, UAV 100 has various outputs that are not part of the flight control system. For example, UAV 100 can have a loudspeaker for communicating with people or other UAVs 100. Similarly, UAV 100 can have a flashlight or laser. The laser can be used to “tag” another UAV 100.

FIG. 4 shows control transmitter 400 according to some embodiments. Control transmitter 400 can send control signals to transceiver 365. Control transmitter can have auxiliary switches 410, joysticks 415 and 420, and antenna 405. Joystick 415 can be configured to send elevator and aileron control signals while joystick 420 can be configured to send throttle and rudder control signals (this is termed a mode 2 configuration). Alternatively, joystick 415 can be configured to send throttle and aileron control signals while joystick 420 can be configured to send elevator and rudder control signals (this is termed a mode 1 configuration). Auxiliary switches 410 can be configured to set options on control transmitter 400 or UAV 100. In some embodiments, control transmitter 400 receives information from a transceiver on UAV 100. For example, it can receive some current flight characteristics from UAV 100.

FIG. 5 shows display 140 according to some embodiments. Display 140 can include battery 505 or another power source, display screen 510, and receiver 515. Display 140 can receive a video stream from transmitter 320 from UAV 100. Display 140 can be a head-mounted unit as depicted in FIG. 5. Display 140 can be a monitor such that multiple viewers can view a single screen. In some embodiments, display screen 510 includes two screens, one for each eye; these screens can have separate signals for stereoscopic viewing. In some embodiments, receiver 515 is mounted on display 500 (as shown in FIG. 5), alternatively, receiver 515 can be a separate unit that is connected using a wire to display 140. In some embodiments, display 140 is mounted on control transmitter 400.

FIG. 6 illustrates an exemplary computing system 600 that may be used to implement an embodiment of the present invention. For example, any of the computer systems or computerized devices described herein, such as the UAV 100, the control transmitter 400, the display 140, or the translation server 120 may, in at least some cases, include at least one computing system 600. The computing system 600 of FIG. 6 includes one or more processors 610 and memory 610. Main memory 610 stores, in part, instructions and data for execution by processor 610. Main memory 610 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 610 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD), a plasma display, an organic light-emitting diode (OLED) display, an electronic ink display, a projector-based display, a holographic display, or another suitable display device. Display system 670 receives textual and graphical information, and processes the information for output to the display device. The display system 670 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 600 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 600 may be part of a multi-computer system that uses multiple computer systems 600, each for one or more specific tasks or purposes. For example, the multi-computer system may include multiple computer systems 600 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 600 from different networks communicatively coupled together via the internet (also known as a “distributed” system).

While various flow diagrams provided and described above may show a particular order of operations performed by certain embodiments of the invention, it should be understood that such order is exemplary. Alternative embodiments may perform the operations in a different order, combine certain operations, overlap certain operations, or some combination thereof.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for visual translation, the method comprising:
storing a translation rule in a memory, the translation rule identifying a pre-translation object and a post-translation object that corresponds to the pre-translation object;
receiving a camera feed from a camera of an unmanned aerial vehicle (UAV);
recognizing an instance of the pre-translation object within the camera feed;
modifying the camera feed to replace the instance of the pre-translation object in the camera feed with an instance of the post-translation object; and
transmitting the modified camera feed to a display, thereby triggering display of the modified camera feed via the display.

2. The method of claim 1, further comprising modifying the camera feed to insert visual information, the visual information including at least one of an alphanumeric string, a two-dimensional image, a three-dimensional model, a two-dimensional video, or an animated three-dimensional model.

3. The method of claim 1, wherein modifying the camera feed to replace the instance of the pre-translation object in the camera feed with the instance of the post-translation object includes modifying the camera feed to erase at least a portion of the instance of the pre-translation object.

4. The method of claim 1, further comprising a second camera feed from a second camera of the UAV, wherein recognizing the instance of the pre-translation object within the camera feed is based on the second camera feed as well.

5. The method of claim 1, further comprising a distance feed from a distance tracker of the UAV, wherein recognizing the instance of the pre-translation object within the camera feed is based on the distance feed as well, wherein the distance tracker includes at least one of a laser rangefinder, a radar device, a sonar device, or a lidar device.

6. The method of claim 1, wherein recognizing the instance of the pre-translation object within the camera feed is based on detection of one or more edges within the camera feed.

7. The method of claim 1, wherein recognizing the instance of the pre-translation object within the camera feed is based on recognition of one or more colors within the camera feed.

8. The method of claim 1, wherein recognizing the instance of the pre-translation object within the camera feed is based on recognition of a quick response (QR) code within the camera feed.

9. The method of claim 1, wherein recognizing the instance of the pre-translation object within the camera feed is based on recognition of a facial feature within the camera feed.

10. The method of claim 1, wherein recognizing the instance of the pre-translation object within the camera feed is based on recognition of a logo within the camera feed.

11. The method of claim 1, wherein the display is one of a head-mounted display, a display screen, or a projector.

12. The method of claim 1, wherein the instance of the post-translation object includes at least one of an alphanumeric string, a two-dimensional image or a two-dimensional video.

13. The method of claim 1, wherein the instance of the post-translation object includes at least one of a static three-dimensional model or an animated three-dimensional model.

14. The method of claim 1, further comprising:
storing an audio translation rule in the memory, the audio translation rule identifying a pre-translation audio clip and a post-translation audio clip that corresponds to the pre-translation audio clip;
receiving an audio feed from one or more microphones of the UAV;
recognizing an instance of the pre-translation audio clip within the audio feed;
modifying the audio feed to replace the instance of the pre-translation audio clip in the audio feed with an instance of the post-translation audio clip; and
transmitting the modified audio feed to an audio output device associated with the display.

15. A system for visual translation, the system comprising:
a memory that stores a translation rule, the translation rule identifying a pre-translation object and a post-translation object that corresponds to the pre-translation object;
a communication transceiver that receives a camera feed from a camera of an unmanned aerial vehicle (UAV); and
a processor coupled to the memory, wherein execution of instructions stored in the memory by the processor:
recognizes an instance of the pre-translation object within the camera feed,
modifying the camera feed to replace the instance of the pre-translation object in the camera feed with an instance of the post-translation object, and
triggers transmission of the modified camera feed to a display via the communication transceiver, thereby triggering display of the modified camera feed via the display.

16. The system of claim 15, wherein the display is one of a head-mounted display, a display screen, or a projector.

17. The system of claim 15, wherein the instance of the post-translation object includes at least one of an alphanumeric string, a two-dimensional image or a two-dimensional video.

18. The system of claim 15, wherein the instance of the post-translation object includes at least one of a static three-dimensional model or an animated three-dimensional model.

19. The system of claim 15, wherein the memory also stores an audio translation rule that identifies a pre-translation audio clip and a post-translation audio clip that corresponds to the pre-translation audio clip, wherein the communication transceiver also receives an audio feed from one or more microphones of the UAV, and wherein execution of the instructions by the processor further:
recognizes an instance of the pre-translation audio clip within the audio feed,
modifies the audio feed to replace the instance of the pre-translation audio clip in the audio feed with an instance of the post-translation audio clip, and
triggers transmission of the modified audio feed to an audio output device associated with the display.

20. A non-transitory computer-readable storage medium, having embodied thereon a program executable by a processor to perform a method for visual translation, the method comprising:
storing a translation rule in a memory, the translation rule identifying a pre-translation object and a post-translation object that corresponds to the pre-translation object;
receiving a camera feed from a camera of an unmanned aerial vehicle (UAV);
recognizing an instance of the pre-translation object within the camera feed;
modifying the camera feed to replace the instance of the pre-translation object in the camera feed with an instance of the post-translation object; and
transmitting the modified camera feed to a display, thereby triggering display of the modified camera feed via the display.
